(19) United States
(12) Patent Application Publication
(10) Pub. No.: US 2006/0294064 A1
(43) Pub. Date: Dec. 28, 2006

(54) Storing queries on devices with rewritable media

(75) Inventors: Oren Rosenbloom, Redmond, WA (US); Vladimir Sadovsky, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/165,193

(22) Filed: Jun. 24, 2005

(51) Int. Cl. G06F 17/30

(52) U.S. Cl. 707/3

(57) ABSTRACT

A system and method for preparing and storing pre-determined queries on devices with large re-writable media. This invention addresses the problem of processing of data query request on devices that may not have the processing power to return query results in a timely manner. A requesting device queries a target device for information, such as information relating to the content stored on the target device. If the target device is not capable of providing a timely query result, the target device does not respond to the query request, but instead stores the query. The next time the target device connects to a device with a high-powered processor, such as a personal computer, the processor device generates a query result and stores the query result on the target device. The next time the target device connects to the requesting device, the query result will be provided to the requesting device.

### CROSS-REFERENCE TO RELATED APPLICATIONS

None.

### STATEMENT REGARDING FEDERALLY SPONSORED RESEARCH OR DEVELOPMENT

None.

### BACKGROUND

Increasingly, consumer electronic devices have the ability to share information. Many consumer electronic devices include content, such as media content, that may be accessed by other devices. For example, a personal music player may be capable of transmitting music files to an automobile stereo, a home stereo, or a television set, which may play back the music files. As another example, a camera may transmit photograph files to a printer to be printed, or to a laptop computer containing a photo editor program.

In such situations, it may be advantageous for one device to query another device, for example, to obtain information about its contents. For example, a television connected to a personal music player may query the music player to obtain a list of the music files available, or a printer may query a camera to obtain a list of the photographs to be printed.

However, many devices designed for capturing or storing content may include a relatively small processor and relatively large storage capacity. These devices may not be well-suited to generate responses to particular query requests. For example, some devices may lack the processing capability to quickly respond to complex query requests that include operating over a large data set. These devices may be unable to respond to query requests in a timely manner.

### SUMMARY

In various embodiments, a system and method are provided for preparing and storing pre-determined queries on devices with large re-writable media. When a target device receives a query request to which it is unable to respond in a timely fashion, the target device will store the query request. When the target device connects to a personal computer for a sync operation, or is otherwise placed in communication with a machine that has relatively large processing power, the personal computer or other processing device will respond to the query request, and store the query result on the target device. In this way, a more capable device, such as a personal computer or other processing device, responds to the query request and authors the query result.

In one particular embodiment, the personal computer or other processing devices may be used simply as an authoring device. In this embodiment, the processing device may not make any requests of the target device, but rather generates results to queries based on historic information, user information, or other information not stored on the target device.

In one embodiment, a processing device may perform a method for responding to query requests. The method may include obtaining at least one query request from a target device, the query request being generated by a requesting device, and determining whether to respond to the query request. The method may further include, if the query request is to be responded to, generating a query result in response to the query request and sending the query result to be stored in the target device for consumption by the requesting device. The method may be embodied in computer-executable instructions stored on one or more computer-readable media.

In another embodiment, a target device may perform a method for responding to query requests. The method may include obtaining at least one query request from a requesting device, the query request being generated by a requesting device, and determining whether a query result responsive to the query request is available in local storage. The method may further include, if a query result responsive to the query request is available in local storage, sending the query result to the requesting device; and if a query result responsive to the query request is not available in local storage, determining whether to respond to the query request. The method may also include, if the query request is to be responded to, generating a query result in response to the query request and sending the query result to the requesting device; and if the query request is not to be responded to, storing the query result for future transmission to a processing device. The method may be embodied in computer-executable instructions stored on one or more computer-readable media.

In still another embodiment, a requesting device may perform a method for preparing and receiving a response to a query request. The method may include generating a query request, sending the query request to a target device, and obtaining at least one query result from a target device, the query result being responsive to the query request and being generated by a processing device. The method may be embodied in computer-executable instructions stored on one or more computer-readable media.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawings figures, wherein:

FIG. 1 is block diagram illustrating a computerized environment in which embodiments of the invention may be implemented;

FIG. 2 is a block diagram showing a system in accordance with an aspect of the present invention;

FIG. 3 is a flow chart illustrating a method for queuing a request, in accordance with an embodiment of the present invention; and

FIG. 4 is a flow chart illustrating a method for connecting to a processor device, in accordance with an aspect of the present invention.

### DETAILED DESCRIPTION

In one implementation, the invention relates to a system and method for preparing and storing pre-determined queries on devices with large re-writable media.

This invention addresses the problem of processing of data query request on devices that may not have the processing power to return data set results in a timely manner. A requesting device may query a target device for information, such as information relating to the content stored on the target device. If the target device is not capable of providing a timely query result, the target device may not respond to the query request, but may instead store the query. The next time the target device connects to a device with a high-powered processor, such as a personal computer, the processor device may produce the query result, which may be based on the contents of the target device, and may store the query result on the target device. The next time the target device connects to the requesting device, the query result will be provided to the requesting device.

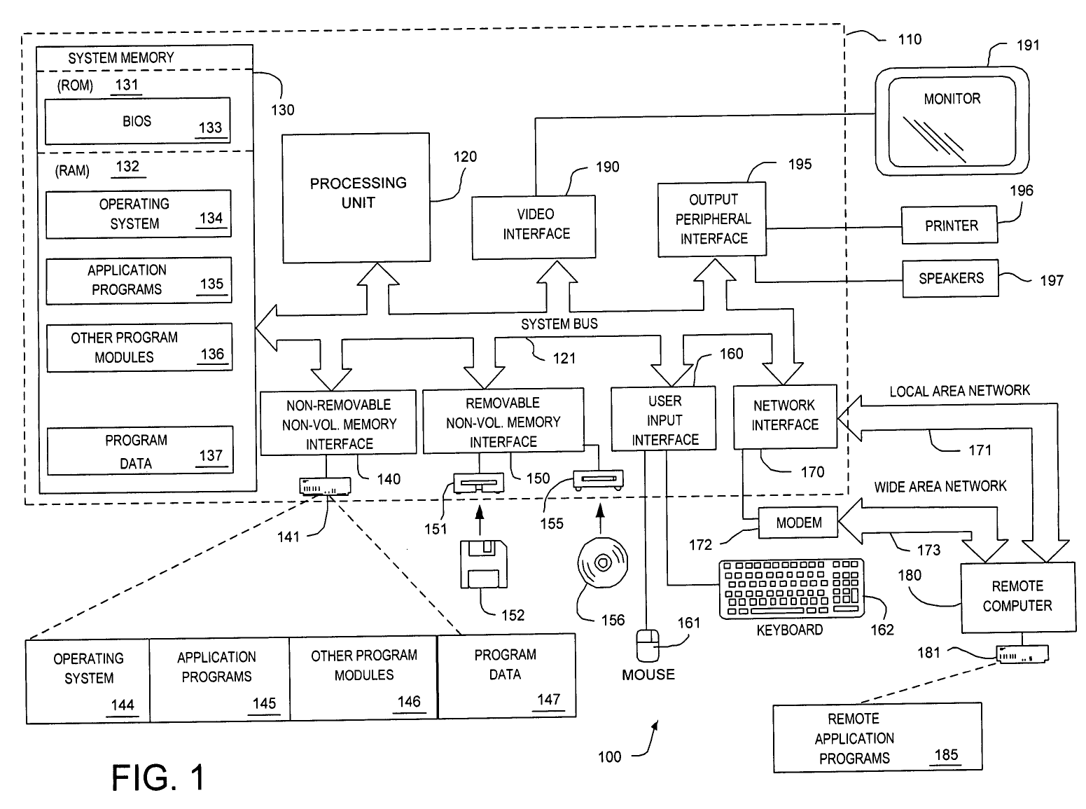

FIG. 1 illustrates an example of a suitable computing system environment 100 on which the system for preparing, storing, or processing queries may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

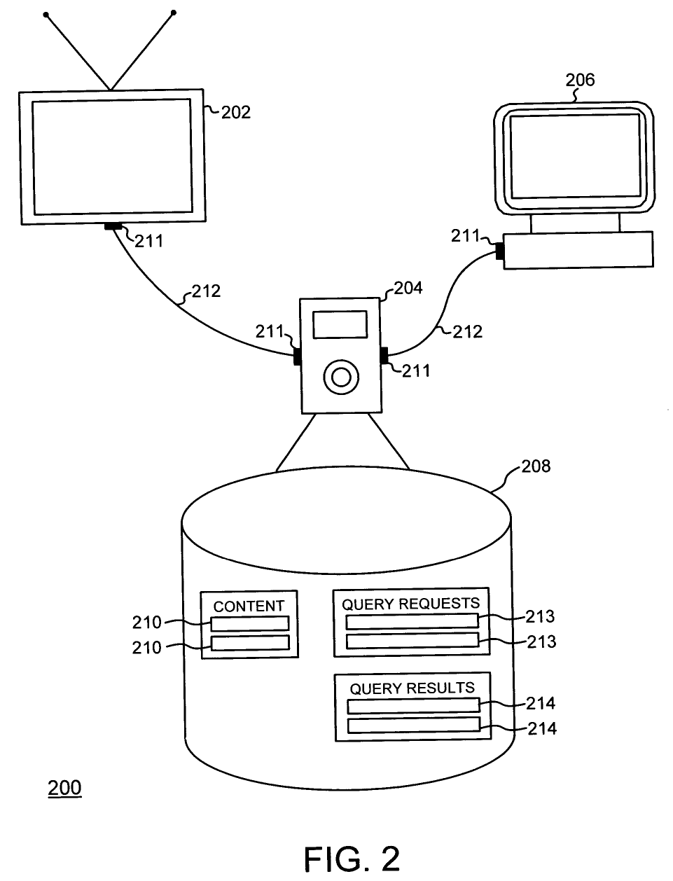

FIG. 2 is a block diagram illustrating an overview of a system in accordance with an embodiment of the present invention. As shown in FIG. 2, a system 200 may include a requesting device 202, such as a consumer electronic device. The requesting device 202 may communicate with a target device 204, such as another consumer electronic device. The target device may further communicate with an Initiator 206, which may be a device with relatively high processing power, such as a personal computer or the like.

The target device 204 may include storage 208, which may store content 210, such as media content. In operation, the requesting device 202 may retrieve content 210 from the target device 204. For example, the requesting device 202 may retrieve content 210 in order to perform playback, editing, printing, or some other operation on the content 210.

Each of the requesting device 202, the target device 204, and the Initiator 206 may be equipped with one or more storage readers and/or writers. Each of the requesting device 202 and the target device 204 may be, for example, an automotive built-in media system, a portable digital stereo system, a non-networked home entertainment system with built-in storage, a camera, a portable gaming device, a mobile telephone, a printer, a personal digital assistant (PDA), or any other electronic system.

The requesting device 202, the target device 204, and the Initiator 206 each implement a protocol that allows for the exchange of information when a network connection is established. For example, the requesting device 202, the target device 204, and the Initiator 206 may have Universal Serial Bus (USB) connectors 211 that allow for connection via direct USB cables 212 or some combination of USB cables and USB hubs. In some implementations, the requesting device 202, the target device 204, and the Initiator 206 may implement Media Transfer Protocol (MTP) to allow for the transfer of media objects. In other implementations, wireless peer-to-peer communication may be used, such as, for example, communication between devices implementing Bluetooth, Ultra Wideband (UWB), or 802.11 technologies. Those skilled in the art will appreciate that other transfer protocols may be used.

In operation, when the requesting device 202 and the target device 204 are connected, the requesting device 202 may query the target device 204. For example, the requesting device 202 may query the target device 204 to obtain metadata related to the content 210 stored in the target device 204. In querying the target device 204, the requesting device 202 may generate one or more query requests 213, which are transmitted to the target device 204.

When the target device 204 receives a query request 213 from a requesting device, the target device 204 may determine whether it is to generate a query result. Determining whether the target device 204 is to generate a query result may depend, for example, on whether the target device 204 has sufficient processing power to generate a query result in a timely fashion. The target device 204 may generate a query result 214 and return the query result to the requesting device 202.

If the target device 204 is not to generate a query result, the target device may store the query request 213. The query request 213 may not be responded to at this time. Rather, the query request 213 may be responded to at a later time, when the target device connects to the Initiator 206.

When the target device 204 connects to the Initiator 206, the Initiator may search the target device 204 for pending query requests. If pending query requests are found, the Initiator may determine whether it is to act as a processing device to generate a query result. If the Initiator 206 determines that it has sufficient processing power or is otherwise suited to act as a processing device, the Initiator 206 may generate one or more query results 214 and stores them on the target device 204.

The next time the requesting device 202 and the target device 204 are connected, the requesting device 202 may retrieve the query requests 214 from the target device 204.

In one implementation, both the query request 213 and the query result 214 may contain an object representing the original query as generated by the requesting device 202. This may ensure, for example, that duplicate query requests 214 are not stored in the target device 204, or that query results 213 that are already present may be returned on response to new query requests when appropriate. Furthermore, the query requests 214 may contain a Boolean variable or other marker to indicate whether they are pending requests or have already been responded to. This may ensure, for example, that query requests are not unnecessarily responded to multiple times.

In some cases, the query requests 213 may be related to the content 210 stored on the target device 204 , or otherwise related to the target device 204. However, in other cases, the query requests 213 may be unrelated to the target device 204. The query requests 213 may be related, for example, to the requesting device 202, to the Initiator 206, to another external device, or may be requests for general information. In this way, the target device 204 may be used to transport information between the requesting device 202 and the Initiator 206. For example, a television set could query a personal music player for television guide information. When the personal music player connects to a personal computer, the personal computer could obtain television guide information from the Internet, from its own storage, or from some other source. The personal computer could store the television guide information on the personal music player as a query result. When the personal music player connects to the television, the television may obtain the television guide information from the personal music player. Those skilled in the art will appreciate that this example is merely illustrative, and will contemplate other ways in which the target device 204 can be used to transport information between the requesting device 202 and the Initiator 206.

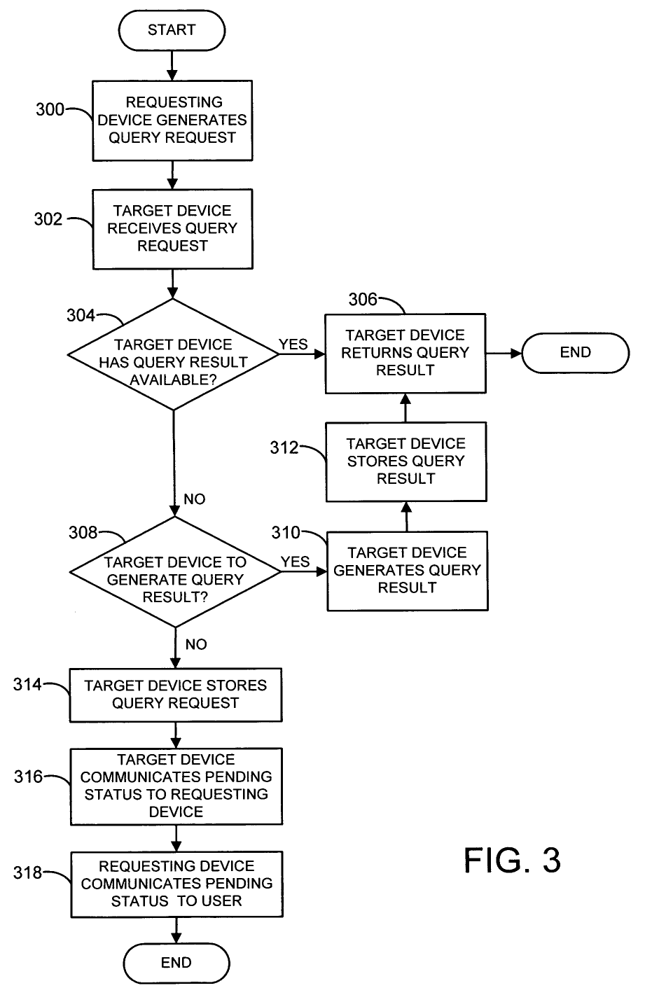

FIG. 3 is a flow chart illustrating a method for queuing a request. As shown in FIG. 3, the method may begin in step 300, wherein a requesting device may generate a query request. The query request may be, for example, a request for information relating to a target device. Alternatively, the query request may be a request for information relating to the requesting device, information relating to a processing device, information related to another external device, or general information.

In step 302, the target device may receive the query request. In step 304, the target device determines whether the query result is available. For example, if the target device has already obtained the query result from a processing device, the target device will contain the query result, and the query result will be available. If the requesting device is making the query request for the first time, the target device will likely not have the query result available.

If the query result is available, such as, for example, if the target device has previously received the query result from a processing device or if the target device has previously generated the query result, the target device will return the query result to the requestor in step 306.

If the query result is not available, it may be determined in step 308 whether the target device is to generate the query result. For example, if the target device has a relatively powerful processor and/or has relatively little storage, the target device may be able to generate the query result. Determining whether the target device is to generate the result may be determined, for example, based on the processing power of the target device, the storage of the target device, and the particular query request. If it is determined in step 308 that the target device is to generate the result set, the target device may generate the result set in step 310. The target device may store the result set in step 312. Thus, the next time the requesting device or another device makes an identical query request, the query result may be available in step 304 and may be returned in step 306.

In some implementations, not only the query result but also the query request may be stored in step 312. For example, the query request may be stored in a queue to indicate that the query request is an ongoing request, and that a new query result should be generated in response to the query request on a regular basis. For example, the query request stored in the queue may indicate that a new query result should be generated every time the content stored in the target device changes, every time the target device connects to the requesting device, or the like.

If it is determined in step 308 that the target device is not to generate the result set, the method may continue in step 314, wherein the target device may store the query request. For example, the target device may store the query request in a queue so that it may be responded to at a later time by a processor device. In some cases, the query request may be persistent, and may remain in the queue even after it has been responded to. A persistent query request may indicate, for example, that the query request is to be responded to on a regular basis, such as every time the target device connects to the processor device. In other cases, the query request may persist only until it is responded to. This type of query request may be known as a “one-time” query request, and may indicate that the query request is to be responded to only once. It will be appreciated by those skilled in the art that other types of query requests that persist for other lengths of time could be used.

In step 316, the target device may communicate “pending” status to the requesting device. This indicates, for example, that the query request has been queued and will be responded to at a later time, such as when the target device connects to a processing device. In step 318, the requesting device may communicate pending status to the user, such as by presenting a user with a dialogue box indicating that the query request will be responded to at a later time, or by any other appropriate method.

While the method has been described as either returning a query result or queuing a query request, in some implementations, a query result may be returned and a query request may be queued. For example, a target device may have available, or may be able to generate, a partial query result to a particular query request. In this case, the target device may return a partial query result to the requester and may also store the query request to be responded to at a later time. As a particular example, a television may request a list of all the music on a personal music player. The personal music player may be capable of returning the list of file names very quickly, but may not be capable returning the metadata associated with each file, such as the title, the artist, and the like, in a timely fashion. In this case, the personal music player may return the list of file names, and may also stores the query request. The personal music player may store the complete query request, or may store only a partial query request, for example, the portion of the query request that has not yet been responded to. When the personal music player is connected to a processor device and the result set is created and stored on the personal music player, upon next connection with the television, the personal music player can return a complete query result including a richer set of metadata, rather than returning only the file name.

Other circumstances may result in a target device both returning a query result and storing a query request. As another example, a target device may be capable of responding to a query request, but the target device may take a relatively long period of time to do so. In this case, the target device may respond to the query request, but may store the query request and mark it as “underperforming.” The next time the target device connects to a processing device, the processing device may generate a query result responsive to the query request and store it on the target device, so that a subsequent query request could be responded to in a shorter period of time. This embodiment may be useful, for example, when the requestor is not capable of handling “pending” query requests, but is capable of waiting a relatively long period of time for a query result. To implement such embodiments, each target device may store a threshold value, and all query requests that result in a processing time over the threshold value could be queued.

In one implementation, Media Transfer Protocol (MTP) is used to standardize communication between the requesting device, the target device, and the processing device. In other implementations, other communication protocols are possible. Although the invention is not limited by the communication protocol used, one particular implementation will be discussed, in which MTP is used.

In this implementation, the requesting device may use the MTP GetObjectPropList operation to generate a query request 300 and to issue the query request to the target device 302. The target device may attempt in step 304 to find an object stored in its file system that represents the query results for this query. If no such object is found, the target device may determine 308 whether to generate a query result.

Determining if the request should be generated by the target device 308 is a heuristic that can be device dependent. It may depend, for example, on the characteristics of the device's processing capabilities, the size and speed of its data storage, and the communication bus to which it is currently satisfying the request. Similarly, another heuristic will be used to determine if the target device is connecting to a processing device or another device that is capable of processing the query results. This heuristic will be on the side of the processing device, which may be termed the “Initiator.” When the target device connects to an Initiator, the Initiator may interrogate the target device to determine if it can act as a processing device to respond to the query.

If the target device determines 308 that it is to generate the query result, the target device will satisfy the query request by producing a query result set 310. The target device may then optionally produce an MTP object with a format code that suitably describes the object as a query result set. This object may also have metadata properties set so that future query requests can be compared with this object and determined if this object is a suitable query result set.

If the target device determines 308 that it should defer the result set creation to a more powerful processor device or personal computer, in step 314, it may create an MTP object with a format code that indicates that this is a pending query that needs processing.

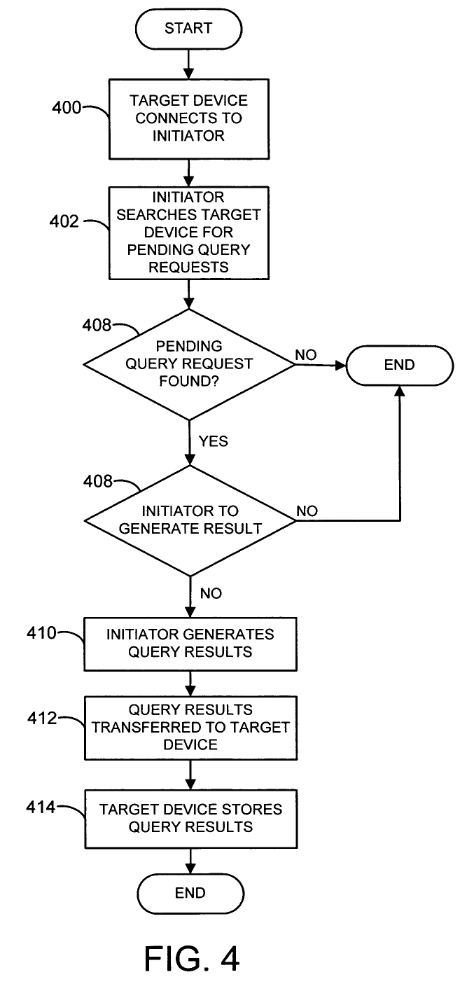

FIG. 4 is a flow chart illustrating a method for connecting to a processor device. As shown in FIG. 4, the method may begin in step 400, wherein a target device may connect to an Initiator, such as a personal computer, laptop computer, or other computing device. In one implementation, the target device connects to the Initiator during a sync operation. In this case, much of the metadata and other information that is used in the method of FIG. 4 may be transmitted between the target device and the Initiator during the sync operation and used for other purposes. Thus, in performing the method of FIG. 4 concurrently with a sync operation or other such operation, bandwidth may be reduced and the total communication time between the target device and the Initiator may be reduced.

In step 402, the Initiator may search the target device for pending query requests, such as, for example, by retrieving one or more queries from a queue. In step 406, it is determined whether any pending query requests have been found. If no pending query requests have been found, the method may end.

If one or more pending query requests are found, the method may continue in step 408, wherein the Initiator may determine whether it is to generate a query result for one or more of the pending query requests. When the target device connects to an Initiator, the Initiator may interrogate the target device to determine if it can act as a processing device to respond to one or more of the pending query requests. Determining whether the Initiator is to generate the result 408 may be determined, for example, based on the processing power of the Initiator, the storage of the target device, and the particular query request. Determining if the query result should be generated by the Initiator 408 is a heuristic that may depend, for example, on the characteristics of the Initiator's processing capabilities, the size and speed of the target device's data storage, and the communication bus to which it is currently satisfying the request. This heuristic may be on the side of the Initiator.

If the Initiator determines that it is not to generate a query result for any of the pending query requests, for example, because the Initiator lacks sufficient processing power or for some other reason, the method may end. If the Initiator determines that it is to generate a query result for one or more of the pending query requests, the Initiator acts as a processing device, and the method may continue in step 410.

In step 410, the Initiator generates one or more query results responding to one or more of the pending query requests. In one implementation, for each query request, the Initiator will issue suitable commands to the target device so that it can operate over its contents and produce query results. In one implementation, the query results may contain metadata as requested by the query request, and may also contain an index, such as an Object Handle in MTP, that links this metadata to the actual object on the device. Furthermore, the query results may be in a file format that can be easily consumed by the original query requester. One method of producing query results in such an easily consumable file format is to produce the result set in the same form as MTP results produced by the GetObjectPropList operation, specifically the ObjectPropList dataset. Yet another way to produce query results in an easily consumable file format is for the requesting device to specify to the target device the format for which it wishes to receive the results. The Initiator will then produce the query results in this easily consumable format.

In step 412. the query results may be transferred to the target device. In step 414, the target device may store the query results. In one implementation, the query results may be marked, as with a format code or by some other appropriate method, to indicate it is a result set. In one implementation, the metadata associated with each query result will contain the original query request object. The original query request can be included, for example, as a binary object property, or linked to the query result with an MTP reference. Depending on how long the query request is to persist, the query request may be removed from the queue, or may be marked to indicate that it is no longer pending.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

For example, while the requester has been described as creating and storing a complete query, embodiments of the invention allow for the requester to utilize “query templates.” Query templates are, for example, queries that contain one or more parameter references in lieu of particular parameters. The parameter references may be filled in by the processing device when query results are to be generated. For example, a requestor may send a query request to a personal video player, asking for a list of the most recently recorded television programs. In this case, one of the parameters in the query request would be “today's date.” Rather than specifying the date in the query request, the requester may generate a query request including a parameter reference, such as % date %. When the processing device responds to the query, the processing device will substitute a specific value, such as the current date, for the parameter reference.

In embodiments of the present invention, removable storage is as a target device. In this case, removable storage, such as a microdrive, may used for communication between a media device and a personal computer. In this case, the removable storage may contain a large media content collection along with query requests and associated query results. In this case, the removable storage could be inserted into a personal computer to transfer content from a media device to the personal computer, as during a sync operation, while also communicating device information regarding the media device. When the removable storage is later inserted into the media device, stored query results could be used to accelerate access to the media content on the removable storage. When the media device has a query request regarding the content of the removable storage, it determines whether it is able to generate a query result in a timely fashion. If the media device is not able to generate a query result in a timely fashion, it stores the query request on the removable storage. When the removable storage is placed in the personal computer, the personal computer may generate query results and store the query results on the removable storage for later consumption by the media device.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. Moreover, although reference numerals, the terms “step” and/or “block”, and the like may be used herein to connote different elements of methods employed, these reference numerals and terms should not be interpreted as implying any particular order among or between the various method elements herein disclosed unless and except when the order of individual method elements is explicitly described as being required. This is contemplated and within the scope of the appended claims.

What is claimed is:

1. One or more computer-readable media storing instructions thereon, the instructions being executable to cause a processing device to perform a method comprising:
obtaining at least one query request from a target device, the query request being generated by a requesting device;
determining whether to respond to the query request;
if the query request is to be responded to, generating a query result in response to the query request; and
sending the query result to be stored in the target device for consumption by the requesting device.

2. The computer-readable media of claim 1, wherein determining whether to respond to the query request is based on processing power.

3. The computer-readable media of claim 1, wherein determining whether to respond to the query request is based on the content of the target device.

4. The computer-readable media of claim 1, wherein the target device comprises:
a removable storage medium.

5. The computer-readable media of claim 1, wherein generating a query result comprises:
operating on the contents of the target device to produce a query result.

6. The computer-readable media of claim 1, wherein the format of the query result is specified by the requesting device.

7. The computer-readable media of claim 1, wherein the format of the query request and the format of the query result conform to Media Transfer Protocol.

8. One or more computer-readable media storing instructions thereon, the instructions being executable to cause a target device to perform a method comprising:
obtaining at least one query request from a requesting device, the query request being generated by the requesting device;
determining whether a query result responsive to the query request is available in local storage;
if a query result responsive to the query request is available in local storage, sending the query result to the requesting device;
if a query result responsive to the query request is not available in local storage, determining whether to respond to the query request;
if the query request is to be responded to, generating a query result in response to the query request and sending the query result to the requesting device; and
if the query request is not to be responded to, storing the query result for future transmission to a processing device.

9. The computer-readable media of claim 8, wherein determining whether to respond to the query request is based on processing power.

10. The computer-readable media of claim 8, wherein determining whether to respond to the query request is based on content.

11. The computer-readable media of claim 8, wherein determining whether to respond to the query request is based on the query request.

12. The computer-readable media of claim 8, wherein generating a query result comprises:
operating on content to produce a query result.

13. The computer-readable media of claim 8, wherein the format of the query result is specified by the requesting device.

14. The computer-readable media of claim 8, wherein the format of the query request and the format of the query result conform to Media Transfer Protocol.

15. One or more computer-readable media storing instructions thereon, the instructions being executable to cause a requesting device to perform a method comprising:
generating a query request;
sending the query request to a target device; and
obtaining at least one query result from a target device, the query result being responsive to the query request and being generated by a processing device.

16. The computer-readable media of claim 15, wherein the target device determines that it is not to produce the query result.

17. The computer-readable media of claim 15, wherein the query request is to be stored on the target device.

18. The computer-readable media of claim 15, wherein the processing device generates the query result by operating on the contents of the target device.

19. The computer-readable media of claim 15, wherein the format of the query result is specified by the requesting device.

20. The computer-readable media of claim 15, wherein the format of the query request and the format of the query result conform to Media Transfer Protocol.
